(19) United States
(12) Patent Application Publication
(10) Pub. No.: US 2009/0313405 A1
(43) Pub. Date: Dec. 17, 2009

(54) COMPUTER AND PERIPHERAL APPARATUS CONNECTION ARRANGEMENT

(75) Inventors: Kuang-Yu Tseng, Taipei City (TW); Chia-Yen Hsu, Hsin Chuang City (TW); Miao-Tzu Chou, San-Hsia Town (TW)

Correspondence Address: DATAVAN INTERNATIONAL CORP., P.O. BOX 108-00403, TAIPEI, TW

(73) Assignee: DATAVAN INTERNATIONAL CORP., Jhonghe City (TW)

(21) Appl. No.: 12/137,555

(22) Filed: Jun. 12, 2008

(51) Int. Cl. G06F 13/00

(52) U.S. Cl. 710/73

(57) ABSTRACT

A computer and peripheral apparatus arrangement is disclosed to include a computer device having a mainframe and a display screen supported on the mainframe, peripheral apparatus, and a connection structure for fastening the peripheral apparatus to one lateral side of the display screen and electrically connecting the peripheral apparatus to the mainframe of the computer device. The connection structure includes a first connection interface having a male (or female) electric connector and male (or female) fastening members and provided at one lateral side of the display screen, and a second connection interface having a female (or male) electric connector and female (or male) fastening members for connection to the male (or female) electric connector and male (or female) fastening members of the first connection interface.

### BACKGROUND OF THE INVENTION

1. Field of the Invention

The present invention relates to computer technology and more particularly, to a computer and peripheral apparatus connection arrangement, which has peripheral apparatus be fastened to one lateral side of the display screen of the computer device and electrically connected to the mainframe of the computer device.

2. Description of the Related Art

Following fast development of technology, computer devices are intensively used in enterprises, factories, schools and families for word processing, data processing, plotting, work flow control, inventory control and production line quality control. Computer is also intensively used in checking out and accounting for simplifying account computing, checking and eliminating human errors. In department stores, restaurants and shops, cash registers are used at payment counters for ease payment for calculating and recording sales transactions, storing currency and printing a receipt for the customer.

Further, plastic money, such as credit cards, electronic interactive cards, RFID stored-value cards, electronic monetary cards and etc., allows people more spending freedom. Therefore, a payment counter in a department store, restaurant or shop usually provides a computer device or cash register for calculating and recording sales transactions, and other peripheral apparatus such as card reader, barcode recognition device, image recognition device, numeric keyboard, and etc. for handling electronic monetary payment. Using these electronic devices for handling payment may encounter certain problems.

1. The arrangement of the computer device/cash register and related peripheral apparatus occupies much tabletop surface space of the payment counter, affecting the payment operation.

2. The connection lines and cables between the computer device/cash register and related peripheral apparatus may become tangles, obstructing the surrounding sense of beauty.

Therefore, it is desirable to provide a computer and peripheral apparatus connection arrangement that eliminates the aforesaid problems.

### SUMMARY OF THE INVENTION

The present invention has been accomplished under the circumstances in view. It is the main object of the present invention to provide a to provide a computer and peripheral apparatus connection arrangement, which saves tabletop surface space and, keeps the tabletop neat.

To achieve this and other objects of the present invention, the computer and peripheral apparatus connection arrangement comprises a computer device, which comprises a mainframe capable of processing data and a display screen supported on and electrically connected to the mainframe, a main peripheral apparatus, at least one subsidiary peripheral apparatus, and a connection structure adapted for connecting the main peripheral apparatus to one lateral side of the display screen and the at least one subsidiary peripheral apparatus to one lateral side of the main peripheral apparatus opposite to the display screen and to keep the main peripheral apparatus abutted against the respective lateral side of the display screen and the at least one subsidiary peripheral apparatus abutted against the respective lateral side of the main peripheral apparatus for allowing data communication of the mainframe of the computer device with the main peripheral apparatus and the at least one subsidiary peripheral apparatus. The connection structure comprises two first connection interfaces respectively provided at one lateral side of the display screen and one lateral side of the main peripheral apparatus, two second connection interfaces respectively provided at the other lateral side of the main peripheral apparatus and one lateral side of the at least one subsidiary peripheral apparatus and respectively connected to the first connection interfaces to secure the main peripheral apparatus to the display screen and the at least one subsidiary peripheral apparatus to the main peripheral apparatus and to electrically connect the main peripheral apparatus and the at least one subsidiary peripheral apparatus to the mainframe of the computer device.

Each first connection interface comprises a first electric connector and a plurality of first fastening members disposed at different elevations. Each second connection interface comprises a plurality of second fastening members selectively fastened to the first fastening members of the associating first connection interface, and a second electric connector electrically connected to the first electric connector of the associating first connection interface.

### BRIEF DESCRIPTION OF THE DRAWINGS

FIG. 1 is an elevational assembly view of the preferred embodiment of the present invention.

FIG. 2 is an exploded view of the preferred embodiment of the present invention.

FIG. 3 is an exploded view in an enlarged scale of a part of the preferred embodiment of the present invention.

FIG. 4 is a schematic sectional exploded front view of the preferred embodiment of the present invention.

FIG. 5 is an assembly view of FIG. 4.

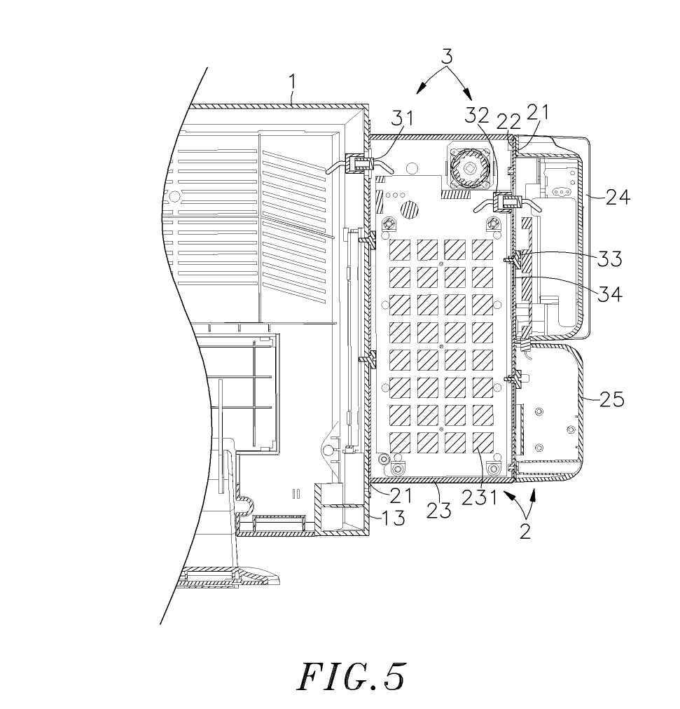

FIG. 6 is an enlarged view of a part of FIG. 4.

FIG. 7 is an enlarged view of a part of FIG. 5.

### DETAILED DESCRIPTION OF THE PREFERRED EMBODIMENT

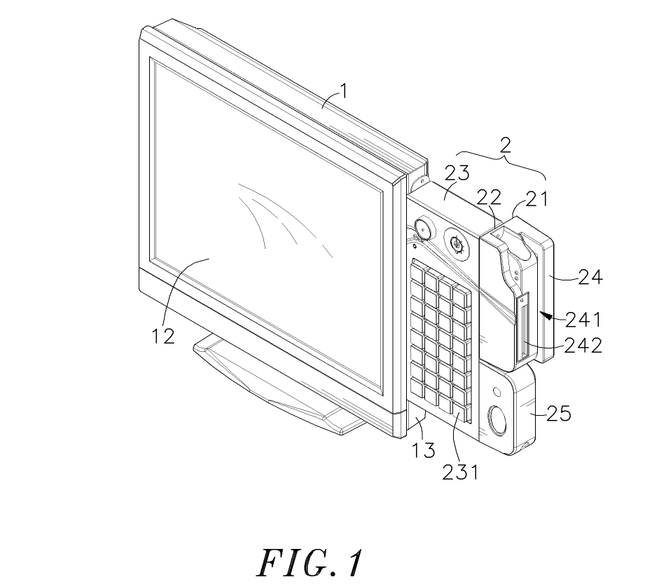

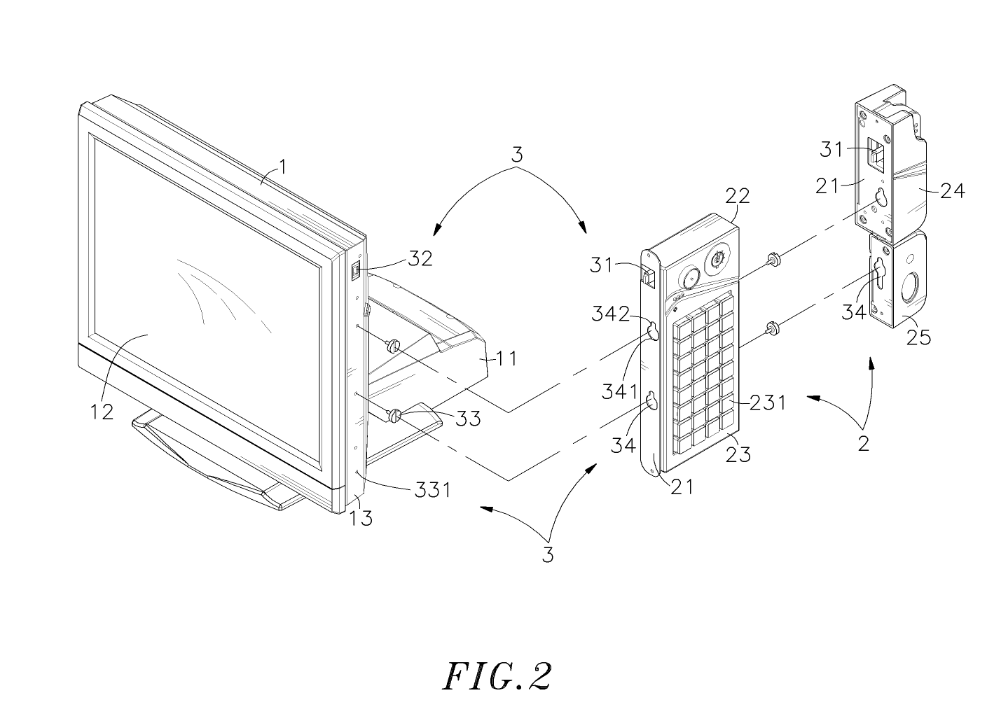

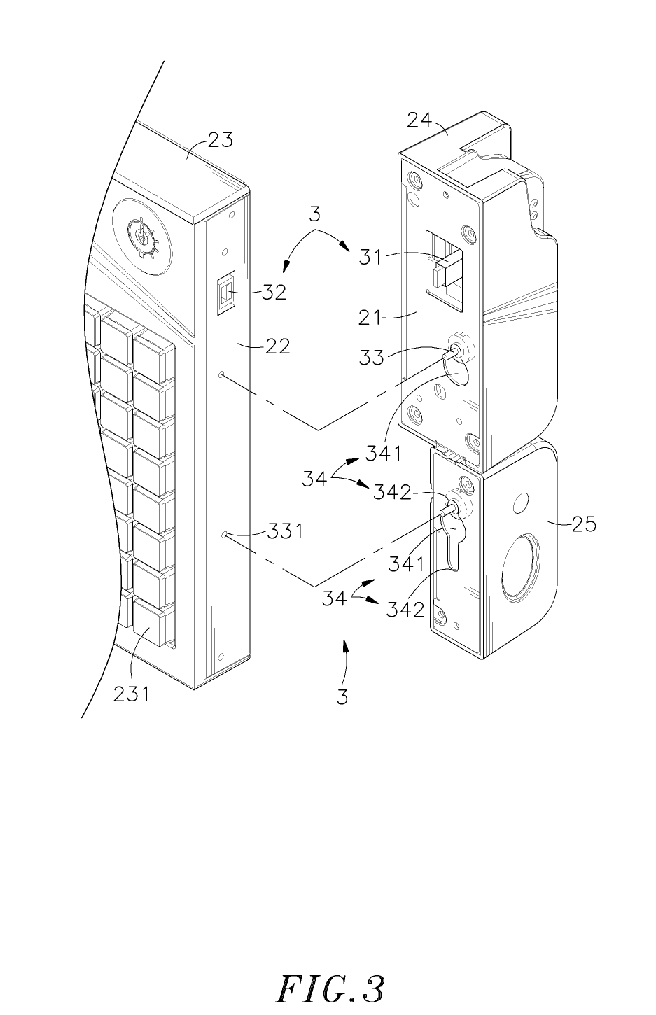

Referring to FIGS. 1 through 3, a computer and peripheral apparatus connection arrangement in accordance with the present invention is shown comprising a computer device 1, a plurality of peripheral apparatus 2, and a connection structure 3 for fastening the peripheral apparatus 2 and the computer device 1 and for allowing communication of the computer device 1 with the peripheral apparatus 2.

The computer device 1 comprises a mainframe 11 for processing data, and a display screen 12 supported on and electrically connected with the mainframe 11 and controlled by the mainframe 11 to display data.

The peripheral apparatus 2 includes a main peripheral apparatus 23 and at least one subsidiary peripheral apparatus 24, 25. According to the present preferred embodiment, the main peripheral apparatus 23 is a keyboard (numeric keypad) having a set of push-button digits 231 for data entry. The at least one subsidiary peripheral apparatus 24, 25 includes two different subsidiary peripheral apparatus 24 and 25 fixedly fastened together and electrically connected together. The first subsidiary peripheral apparatus 24 is a card reader, having a card-reading sliding slot 241 and a card-reading insertion slot 242. The second subsidiary peripheral apparatus 25 is a recognition device, for example, a fingerprint recognition device, barcode recognition device or image recognition device for assuring security of the use of the computer device 1.

The connection structure 3 comprises two first connection interfaces 13 and 22 and two second connection interfaces 21. One first connection interface 13 is provided at one lateral side of the display screen 12. The other first connection interface 22 is provided at one lateral side of the main peripheral apparatus 23. One second connection interface 21 is provided at the other lateral side of the main peripheral apparatus 23 for connection to the first connection interface 13 at the display screen 12. The other second connection interface 21 is provided at one lateral side of the at least one subsidiary peripheral apparatus 24, 25 for connection to the first connection interface 22 at the main peripheral apparatus 23.

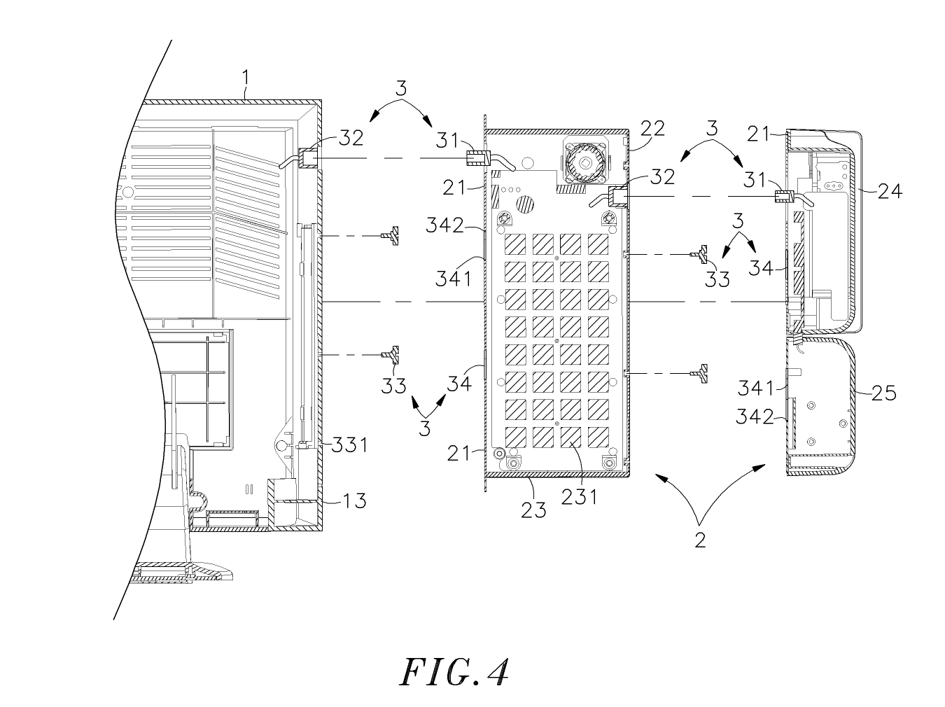

Referring to FIGS. 4˜7 and FIGS. 1˜3 again, the first connection interface 13 or 22 comprises a plurality of mounting holes 331 disposed at different elevations, a plurality of male fastening members 33 respectively mounted in the mounting holes 331, and a female electric connector 32. The mounting holes 331 can be screw holes. The male fastening members 33 can be screw bolts, screw nails, screw rods or rivets respectively affixed to the mounting holes 331. Each second connection interface 21 comprises a plurality of female fastening members 34 for fastening to the respective male fastening members 33 of the associating first connection interface 13 or 22, and a male electric connector 31 for connection to the female electric connector 32 of the associating first connection interface 13 or 22. According to the present preferred embodiment, the female fastening members 34 are keyway-like coupling holes, each having a circular hole 341 and a narrow notch 342 vertically upwardly extending from the circular hole 341 at the top. By means of horizontally inserting the male fastening members 33 into the circular holes 341 of the associating female fastening members 34 and then lowering the second connection interface 21 relative to the associating first connection interface 13, the male fastening members 33 are respectively forced into the narrow notches 342 of the associating female fastening members 34, allowing the main peripheral apparatus 23 to be hung on the male fastening members 33 of the first connection interface 13 at the display screen 12 or the at least one second peripheral apparatus 24, 25 to be hung on the male fastening members 33 of the first connection interface 22 at the main peripheral apparatus 23. At this time, moving the main peripheral apparatus 23 toward the display screen 12 or the at least one second peripheral apparatus 24, 25 toward the main peripheral apparatus 23 to force the male electric connector 31 into the associating female electric connector 32, and thus the connection between the second connection interface 21 and the associating first connection interface 13 or 22 is done.

After installation, the at least one second peripheral apparatus 24, 25 are abutted against one lateral side of the main peripheral apparatus 23 and the main peripheral apparatus 23 is abutted against one lateral side of the display screen 12, therefore the arrangement does not occupy much table space. Further, by means of connecting the respective male electric connectors 31 to the respective female electric connectors 32, the at least one second peripheral apparatus 24, 25 and the main peripheral apparatus 23 are electrically connected to the mainframe 11 of the computer device 1. This installation arrangement eliminates the drawback of tangling of connection cables as seen in prior art designs. Thus, a user can operate the push-button digits 231 of the main peripheral apparatus (keyboard) 23 to input data into the mainframe 11 of the computer device 1 for computing or processing for enabling the computed or processed result to be displayed on the display screen 12. Further, a consumer can pay bills by means of sliding a credit card or electronic money IC card through the card-reading sliding slot 241 or inserting the card into the card-reading insertion slot 242, for enabling the mainframe 11 to read data from the card and to deduct the paid monetary amount from the monetary amount stored in the card. During card reading and monetary amount deducting operation, the related data is displayed on the display screen 12.

As stated above, the second peripheral apparatus 25 is a recognition device that can be a fingerprint recognition device or image recognition device. By means of the second peripheral apparatus 25 to validate the fingerprint or image of a user, the second peripheral apparatus 25 is used as a security device for entry to boost the computer device 1 so that only a qualified person can use the computer device 1. Alternatively, the second peripheral apparatus 25 can be a barcode recognition device for reading the printed barcode data of a product and converting it into a digital form and then sending the digital data to the mainframe 11 for processing and for display on the display screen 12.

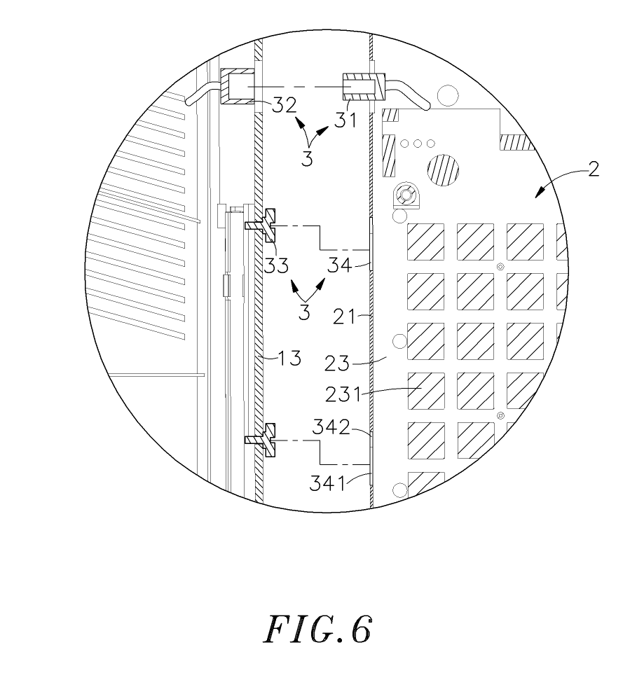

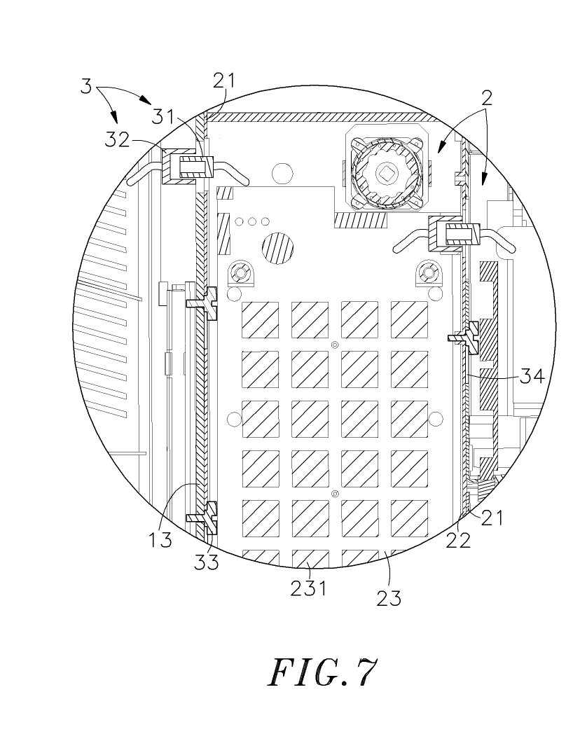

Referring to FIGS. 1, 6 and 7 again, the male electric connectors 31 and the female electric connectors 32 can be made in any of a variety of forms such as USB (Universal Serial Bus), PS/2 (Personal System/2), SATA (Serial Advanced Technology Attachment Interface) or eSATA (External Serial ATA). According to the present preferred embodiment, the male electric connector 31 is provided at each second connection interface 21, and the female electric connector 32 is provided at each first connection interface 13 or 22. Alternatively, the male electric connector 31 can be provided at each first connection interface 13 or 22, and the female electric connector 32 can be provided at each second connection interface 21.

As stated above, the invention provides a computer and peripheral apparatus arrangement, which comprises a computer device 1, a plurality of peripheral apparatus 2, and a connection structure 3 for fastening the peripheral apparatus 2 and the computer device 1 and for allowing communication of the computer device 1 with the peripheral apparatus 2. The connection structure 3 comprises two first connection interfaces 13 and 22 respectively provided at one lateral side of the display screen 12 of the computer device 1 and one lateral side of one peripheral apparatus 2, i.e., the main peripheral apparatus 23, and two second connection interfaces 21 respectively provided at the other lateral side of the main peripheral apparatus 23 and one lateral side of the other peripheral apparatus 24, 25. Each first connection interface 13 or 22 comprises a female electric connector 32 and a plurality of vertically spaced male fastening members 33. Each second connection interface 21 comprises a male electric connector 31 for connection to the female electric connector 32 of the associating first connection interface 13 or 22, and a plurality of vertically spaced female fastening members 34 for connection to the vertically spaced male fastening members 33 of the associating first connection interface 13 or 22. By means of connecting the respective second connection interfaces 21 to the respective first connection interfaces 13, 22, the peripheral apparatus 2 are closely and positively secured to one lateral side of the display screen 12 and electrically connected to the mainframe 11 of the computer device 1 so that a user can input data or signal into the mainframe 11 for computing and processing, enabling the computed or processed result to be displayed on the display screen 12.

In conclusion, the invention provides a computer and peripheral apparatus arrangement, which has the following advantages:

1. By means of the first connection interfaces 13 and 22 and the second connection interfaces 21 of the connection structure 3, peripheral apparatus 2 are closely fastened to one lateral side of the display screen 12 of the computer device 1 and electrically connected to the mainframe 11 of the computer device 1 so that the installation of the peripheral apparatus 2 does not occupy the tabletop surface space.

2. By means of electrically connecting the respective male electric connectors 31 to the respective female electric connectors 32, the peripheral apparatus 2 are electrically connected to the mainframe 11 of the computer device 1 without any external connection lines or cables, keeping the tabletop neat.

Although a particular embodiment of the invention has been described in detail for purposes of illustration, various modifications and enhancements may be made without departing from the spirit and scope of the invention.

What the invention claimed is:

1. A computer and peripheral apparatus arrangement, comprising:
a computer device, said computer device comprising a mainframe capable of processing data and a display screen supported on and electrically connected to said mainframe;
a main peripheral apparatus, said main peripheral apparatus having a first lateral side and a second lateral side opposite to the first lateral side;
at least one subsidiary peripheral apparatus; and
a connection structure adapted for connecting said first lateral side of said main peripheral apparatus to one lateral side of said display screen of said computer device and said at least one subsidiary peripheral apparatus to said second lateral side of said main peripheral apparatus to keep said main peripheral apparatus abutted against said respective lateral side of said display screen and said at least one subsidiary peripheral apparatus abutted against said second lateral side of said main peripheral apparatus for allowing data communication of said mainframe of said computer device with said main peripheral apparatus and said at least one subsidiary peripheral apparatus, said connection structure comprising two first connection interfaces respectively provided at one lateral side of said display screen and said second lateral side of said main peripheral apparatus, and two second connection interfaces respectively provided at said first lateral side of said main peripheral apparatus and one lateral side of said at least one subsidiary peripheral apparatus and respectively connected to said first connection interfaces to secure said main peripheral apparatus to said respective lateral side of said display screen and said at least one subsidiary peripheral apparatus to the second lateral side of said main peripheral apparatus and to electrically connect said main peripheral apparatus and said at least one subsidiary peripheral apparatus to said mainframe of said computer device, each said first connection interface comprising a first electric connector and a plurality of first fastening members disposed at different elevations, each said second connection interface comprising a plurality of second fastening members selectively fastened to said first fastening members of said associating first connection interface and a second electric connector electrically connected to said first electric connector of said associating first connection interface.

2. The computer and peripheral apparatus arrangement as claimed in claim 1, wherein said main peripheral apparatus is a keyboard; said at least one subsidiary peripheral apparatus includes a card reader and a recognition device.

3. The computer and peripheral apparatus arrangement as claimed in claim 2, wherein said recognition device is a fingerprint recognition device.

4. The computer and peripheral apparatus arrangement as claimed in claim 2, wherein said recognition device is a barcode recognition device.

5. The computer and peripheral apparatus arrangement as claimed in claim 2, wherein said recognition device is an image recognition device.

6. The computer and peripheral apparatus arrangement as claimed in claim 1, wherein said first electric connector is a male USB connector, and said second electric connector is a female USB connector connectable to said male USB connector.

7. The computer and peripheral apparatus arrangement as claimed in claim 1, wherein said first electric connector is a female USB connector, and said second electric connector is a male USB connector connectable to said female USB connector.

8. The computer and peripheral apparatus arrangement as claimed in claim 1, wherein said first electric connector is a male PS/2 connector, and said second electric connector is a female PS/2 connector connectable to said male PS/2 connector.

9. The computer and peripheral apparatus arrangement as claimed in claim 1, wherein said first electric connector is a female PS/2 connector, and said second electric connector is a male PS/2 connector connectable to said female PS/2 connector.

10. The computer and peripheral apparatus arrangement as claimed in claim 1, wherein said first electric connector is a male SATA (Serial Advanced Technology Attachment Interface) connector, and said second electric connector is a female SATA (Serial Advanced Technology Attachment Interface) connector connectable to said male SATA (Serial Advanced Technology Attachment Interface) connector.

11. The computer and peripheral apparatus arrangement as claimed in claim 1, wherein said first electric connector is a female SATA (Serial Advanced Technology Attachment Interface) connector, and said second electric connector is a male SATA (Serial Advanced Technology Attachment Interface) connector connectable to said female SATA (Serial Advanced Technology Attachment Interface) connector.

12. The computer and peripheral apparatus arrangement as claimed in claim 1, wherein said first electric connector is a male eSATA (External Serial Advanced Technology Attachment Interface) connector, and said second electric connector is a female eSATA (External Serial Advanced Technology Attachment Interface) connector connectable to said male eSATA (External Serial Advanced Technology Attachment Interface) connector.

13. The computer and peripheral apparatus arrangement as claimed in claim 1, wherein said first electric connector is a female eSATA (External Serial Advanced Technology Attachment Interface) connector, and said second electric connector is a male eSATA (External Serial Advanced Technology Attachment Interface) connector connectable to said female eSATA (External Serial Advanced Technology Attachment Interface) connector.

14. The computer and peripheral apparatus arrangement as claimed in claim 1, wherein said first fastening members of said first connection interfaces are male fastening members, and said second fastening members of said second connection interfaces are female fastening members selectively connectable to said male fastening members.

15. The computer and peripheral apparatus arrangement as claimed in claim 14, wherein each said female fastening member is a keyway-like coupling hole, said keyway-like coupling hole comprising a circular hole and a narrow notch radially extending from said circular hole; each said male fastening members is a bolt member for inserting into said circular hole of one said keyway-like coupling hole and then engaging into said narrow notch of said respective keyway-like coupling hole.

16. The computer and peripheral apparatus arrangement as claimed in claim 1, wherein said first fastening members of said first connection interfaces are female fastening members, and said second fastening members of said second connection interfaces are male fastening members selectively connectable to said female fastening members.

17. The computer and peripheral apparatus arrangement as claimed in claim 16, wherein each said female fastening member is a keyway-like coupling hole, said keyway-like coupling hole comprising a circular hole and a narrow notch radially extending from said circular hole; each said male fastening members is a bolt member for inserting into said circular hole of one said keyway-like coupling hole and then engaging into said narrow notch of said respective keyway-like coupling hole.
